(19) United States
(12) Patent Application Publication
(10) Pub. No.: US 2011/0291843 A1
(43) Pub. Date: Dec. 1, 2011

(54) FIRE ALARM

(76) Inventor: Keld Gade Andersen, Faaborg (DK)

(21) Appl. No.: 13/145,579

(22) PCT Filed: Jan. 21, 2010
(86) PCT No.: PCT/DK2010/050011

§ 371 Date: Aug. 22, 2011

(30) Foreign Application Priority Data
Jan. 22, 2009 (DK) PA 2009 00099
Dec. 11, 2009 (DK) PA 2009 01311

(51) Int. Cl. G08B 17/00

(52) U.S. Cl. 340/584

(57) ABSTRACT

The present invention concerns an apparatus and a method for detecting a fire, which apparatus includes at least one alarm signalling device and at least one detecting unit, and wherein the apparatus interacts with a switchboard. The invention is designed to achieve early warning when abnormal condition occurs in a switchboard, and where an alarm unit can be detached without access to the switchboard power supply. This can be achieved if the apparatus is located in a recess in the cover where the apparatus is connected to the switchboard with at least one connector, and where the connector at least provides power to the apparatus. Hereby it is achieved that the Fire alarm apparatus can be directly removed from the switchboard front without in any way interfering with the electrical installation. Especially when the apparatus is supplied with low voltage through the connector, it will be easy to remove and possibly replace the fire alarm. Disconnecting the fire alarm, in case this is triggered by an error, can thus be performed by pulling the fire alarm out of the recess in the switchboard cover, thereby interrupting any connection to the fire alarm.

### FIELD OF THE INVENTION

The present invention concerns an apparatus for detecting an abnormal environment in an electrical switchboard, which apparatus including at least one alarm signalling device and at least one detector, where the apparatus is supplied by at least one power source, wherein the detector may establish a detection level for at least one fire-dependent parameter, where the detector when exceeding a first threshold for at least one fire-dependent parameter activates at least one alarm signalling device, where the apparatus can interact with a switchboard, the switchboard including at least one mounting rail, on which mounting rail is mounted at least one electrical component, the switchboard being shielded by at least one cover.

The present invention is also concerns a method for detecting fire in electrical switchboards, where a fire alarm detects one or more fire-dependent parameters, where an alarm is triggered if at least one fire-dependent parameter exceeds a predetermined value.

### BACKGROUND OF THE INVENTION

SE 525 182 C2 discloses a fire alarm which is located in a switchboard, where the fire alarm is mounted directly on the switchboard mounting rail. The fire alarm is connected to a power supply which is connected to the electrical installation. In the event that a fire is detected, an audible fire alarm is activated. The fire alarm is equipped with an indicator light that is visible from the outside on the front of the switchboard cover.

EP 1 413 997 A2 also discloses a fire alarm to be installed in a switchboard. It is described how the fire alarm is mounted directly on a standard rail in a switchboard. The fire itself is installed in a common module, which also includes, for example, a number of DC supply circuits to be used in connection with the electric installation. The fire alarm is able to determine both smoke and rising temperature and thus trigger an alarm before a fire occurs in the actual installation.

DE 10 2007 026 898 A1 concerns a built-in-module for mounting on a rail in a switchboard, where this standard module is designed with a number of ventilation openings so that the electronic device that may be placed inside the device can be ventilated automatically and thus cooled .

WO 2006/027336 also discloses an electrical switch intended for automatic installation on a conductor rail, where the switch itself is placed in a special module such that the switch module can be dismounted, thereby automatically disconnecting the electrical connections.

U.S. 2007/0115112 concerns a public grid connected fire alarm, which, because it is a U.S. patent application, refers to a 120 V AC net. It is described how the data transfer from, for example, one alarm to another is possible by using the power cables. Also, it is described how the triggering of a fire alarm in a fire alarm unit is communicated through a comprehensive system that may decide evacuation of a building, or perhaps detect an error alarm to be rejected. This means that several fire alarms communicate through the power cables directly with a main control system which performs fire monitoring of a large building.

DE 299 13 500 U1 discloses an apparatus for mounting in an electrical installation which includes a radio antenna. The rear of the apparatus includes an opening for a battery enclosure, but access to the battery compartment is only possible if the device is removed.

### PURPOSE OF THE INVENTION

The object of the invention is to achieve instant alarm in case of an abnormal condition in a switchboard, where an alarm unit can be dismounted without access to the network voltage of the switchboard.

### DESCRIPTION OF THE INVENTION

The object can be achieved by an apparatus as specified in the preamble of claim 1, if the apparatus is placed in the cover, where the apparatus is connected to the switchboard by at least one connector, the connector providing at least power to the apparatus.

Thus, it can be achieved that the fire alarm apparatus can be dismounted directly from the switchboard front without in any way interfering with the electrical installation. Especially if the apparatus is supplied with low voltage through the connector, it is perfectly simple to remove and possibly replace the fire alarm. Decoupling the fire alarm, if this is triggered by mistake, may thus be performed by pulling the fire alarm out of the recess in the switchboard cover and thereby interrupt any connection to the fire alarm. It thus becomes possible for any non-authorised personnel to service the fire alarm, since there is absolutely no connection to the high voltage power system. As there may be fire alarms of widely varying types, especially in terms of communication to and from fire alarms, it is natural that a fire alarm can be replaced over time. Only during the first installation of a fire alarm, it may be necessary to call in qualified personnel. A power supply to the fire alarm may have to be mounted on the switchboard power rail, with a low voltage outlet and with connection to the fire alarm. Alternatively a power supply for the fire alarm may be permanently installed in a module containing a low voltage outlet to supply the fire alarm.

Installation under the switchboard cover must be performed by authorized personnel. The following installation and commissioning of the fire alarm can be done after the switchboard cover has been fastened, and thus when access to the high voltage power supply is no longer available.

In a preferred embodiment of the apparatus can be placed high in the switchboard front cover. Assuming that smoke and heat ascend when smoke or heat evolves inside the switchboard, it will be most expedient to mount a fire alarm in the upper part of the switchboard. It will also be suitable that there are vents into the fire alarm apparatus so as to achieve good ventilation. Good ventilation can be obtained if there are openings in the rear edge of the apparatus and also openings to the outside from the back side of the apparatus. Thereby, if there is an increase in temperature inside the switchboard, natural circulation of air through the apparatus will occur. By the fact that various components typically arranged in a switchboard, a slight power dissipation and a modest heating will always occur such that there will always be a small air flow out through an opening in the top of the switchboard and through the apparatus containing smoke and temperature sensors. Thereby is ensured a very rapid alarm response.

Having the switchboard temperature to be the first fire dependent parameter detected by the first detector of the apparatus will be advantageous. A first indication that an abnormal condition is about to arise, may well be that a beginning temperature increase is recorded. A bad connection related to a wire into a fuse socket or a group switch may easily mean a dramatic increase in local temperature which rapidly reflects that the temperature at the switchboard rises over a relatively short time span. Thereby, the fastest and relatively most reliable alarm may be achieved.

Another fire-dependent parameter detected by the apparatus second detector can be smoke. The smoke detection may provide rapid indication that there may be a bad connection somewhere in the electrical system. If the smoke detector is particularly designed to detect ions or perhaps carbon monoxide or carbon dioxide, it will soon be able to indicate that a fire is going on somewhere, even with very low concentrations in the smoke. Combined with the fact that the apparatus containing the fire alarm is located at the top of a switchboard, the emitted smoke may quickly be detected at the top of the board. Thus, an alarm can be triggered before the smoke is too heavy. Detection of smoke may thus often occur minutes or maybe half-hours before a fire develops in a switchboard.

The apparatus may compare the detected fire-dependent parameters to reference values stored in a memory device in the apparatus. The apparatus then establishes a normal condition and at least a first and a second alarm condition from the actual detector measurements. By using different alarm levels, it can thus be determined if it apparently is a slightly raised, uncritical temperature, which only means that it is time to make call an electrician for performing service that includes tightening of all terminals, or that there may be need for the installation of a new power group to distribute the power consumption over several groups. This will possibly reduce the temperature rising in a switchboard in a relatively simple way. If the temperature continues to rise, there may be a critical temperature increase that indicates appearance of fire, and if smoke is indicated at the same time there is no doubt that an alarm shall be triggered, and that preventive activity shall be done soon. It may be necessary to conduct a fire extinction of the electrical installation and thus for example make a powder extinguisher ready if fire should develop.

Advantageously, when the second alarm level is exceeded the device may activate power path through a switch and through a current limiting resistance between one phase and an earth connection to activate a residual current circuit breaker to interrupt power supply to the switchboard. The apparatus itself may be designed with an automatic shutdown of the entire installation. If there are indications that a fire is developing critically, the apparatus can activate a conventional residual current circuit breaker by establishing an earth grounding short circuit so that the breaker will isolate the electrical installation. A typical residual current circuit breaker can be activated if a convection between phase and earth with an effect of about 10 milliamps is established. This induces a sufficiently large fault current for the residual current circuit breaker to be activated. There are probably circuit breakers which are much more sensitive, such that an even smaller current may be detected by the breakers and thus perform safety cut-out.

The appliance can communicate over a wireless network, which wireless network is connected with at least one computer. If the apparatus contains, for example, a Wi-Fi computer connection, the individual devices equipped with the fire alarm system can be able to communicate with a computer network using either a desktop or notebook PC to communicate with the fire alarm. This makes it possible to read the actual measurement values off the detectors in the apparatus. It may be possible via a computer connection to load in new threshold values for temperature and smoke, respectively, so as to achieve maximum safety of each installation. Thresholds for temperature may be determined for each installation because the ambient temperatures surrounding the switchboards influence the measured temperature inside the switchboard. Switchboards can be located in many different places. To ensure that no improper temperature increase occurs, it is necessary to read in the actual location of the switchboard, and thereby compensate for the environment in which the switchboard is installed. Another parameter that affects the temperature increase in a switchboard is the actual power consumption which changes when electrical devices switch on and off.

The wireless network may communicate with additional fire alarms. By communicating over a wireless network several fire alarms can communicate with each other. It is thus possible that a fire alarm, which is directly connected with the switchboard, can communicate with other fire alarms that work independently and are placed in other rooms. Thus, activation of a smoke detector somewhere in a building can alert the fire alarm of the switchboard. Similarly, it is possible that all fire alarms can be connected with a computer system so that the fire alarms can be monitored. In the event of an alarm, the signal from the fire alarm could trigger a powder or foam fire extinguisher unit located outside or inside the switchboard.

In an alternative embodiment, the unit can communicate over the electrical network by transmitting/receiving signals over the electrical power supply network, where computers or other fire alarms are also associated with the electricity network with communication means. An alternative form of communication to the wireless computer network is to let computers communicate over the power network. On the basis that the fire alarm, as indicated above, operates in connection with a switchboard, it is natural to choose communication over the electrical network. Other fire alarms can likewise communicate over the electrical network and computers can be linked to the electricity network to communicate this way. Thus, connecting through the public power network gives the same advantages as by using the traditional wireless computer communications.

The purpose is also achieved by a method as described in the preamble of claim 10, where fire alarm is located in a recess in the switchboard front cover, where power supply to the fire alarm is a low voltage supply and the assembly and disassembly of the fire alai in is takes place without contact with the high voltage installation. Thus, a very effective fire monitoring of the switchboard is possible. Also, it is achieved that the fire alarm in the form of the apparatus located in the switchboard is not a high-voltage component and as such can be changed by anyone who may need to service the apparatus. Once a standard module is mounted in a high voltage installation, for example, in a switchboard, a fire alarm will be placed in the switchboard front cover can be replaced or serviced by any unauthorised personnel because the fire alarm comprises a low voltage installation. Likewise, replacement of fire alarm with another type, perhaps with another type of communication, can be fitted into the same socket.

The invention also relates to an apparatus for registration of a fire, which apparatus contains at least one alarm signalling device and at least one detector, which apparatus is supplied by at least one power source, which detector is configured for establishing a measurable level of at least one fire-dependent parameter, which detector when surpassing a first threshold for at least one fire-dependent parameter is configured for activating the at least one alarm signalling device, wherein the apparatus comprises at least one plug-connector configured for connecting said apparatus to a connector for supplying said apparatus with electric power. Such an apparatus for registration of fire is advantageous e.g. in that the apparatus ensures a more reliable fire detection due to the power supply both from the said power source (which may act as a backup power source in case of e.g. grid fall out) of the apparatus, as well as the power supply from the connector. Furthermore, the apparatus for registration of a fire is easy to install and replace due to the plug-connector.

The invention also relates to use of the above mentioned apparatus for registration of fire, where the connector is placed in a recess in a cover shielding a switchboard comprising at least one mounting rail on which mounting rail is mounted at least one electrical component, and in that the connector connects the apparatus to the switchboard. Especially older switchboards comprising e.g. fuses, electric power switches and the like for the electric system of a building may cause an increased risk of fire, e.g. due to the increased need of electric power which the old electrical installation may not be dimensioned for. By installing the apparatus for detection of fire in the switchboard, preferably in an existing recess in the cover of the switchboard, effective and reliable fire detection is achieved. It should be understood that the apparatus for registration of a fire in this embodiment with advantage may comprise a temperature detector for detecting the switchboard temperature and/or the temperature of electrical components of the switchboard.

The invention furthermore relates to use of the above mentioned apparatus for registration of a fire, wherein the said connector is arranged in the ceiling or a wall of a room in a building. This is advantageous in that the apparatus for registration of a fire comprises a plug-connector which facilitates easy installation at various locations of the electric system of a building. The connector may for example be arranged/installed in an existing (and/or new) electric connection area of the electric system in the ceiling or wall. Such an electric connection area may be a standardized connection area/point of the electric system, also facilitating connection of electric lamps or the like.

It is of cause understood that above (as well as below) mentioned aspects/embodiments of the invention may be combined in a multitude of varieties within the scope of protection.

### DESCRIPTION OF THE DRAWING

FIG. 1 shows a switchboard containing a fire alarm.

FIG. 2 shows a section through a switchboard.

FIG. 3 shows the same section through a switchboard as in FIG. 2.

FIG. 4 shows a detail of a switchboard.

FIG. 5 shows a fire alarm installed in casing.

### DETAILED DESCRIPTION OF THE INVENTION

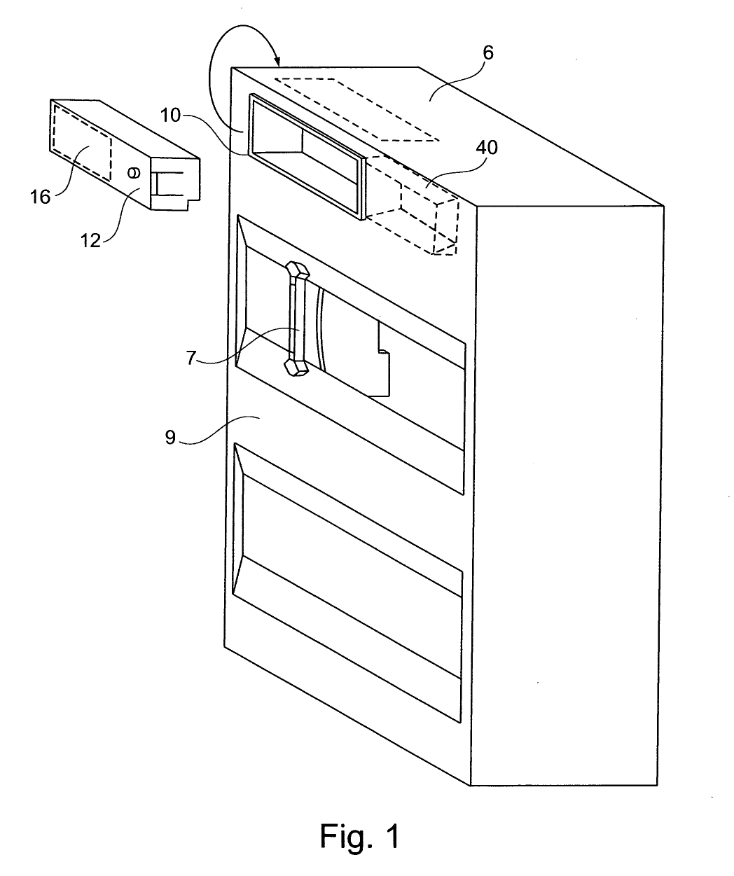

FIG. 1 shows a cover 6, 9 for a switchboard 2. In the cover there is a recess 8 in which a module 10 can be received. The module 10 may include a permanent power supply 40 and a fire alarm 12. Also shown is a front plate 16 which provides access to, for example, replacement of batteries in the fire alarm 12.

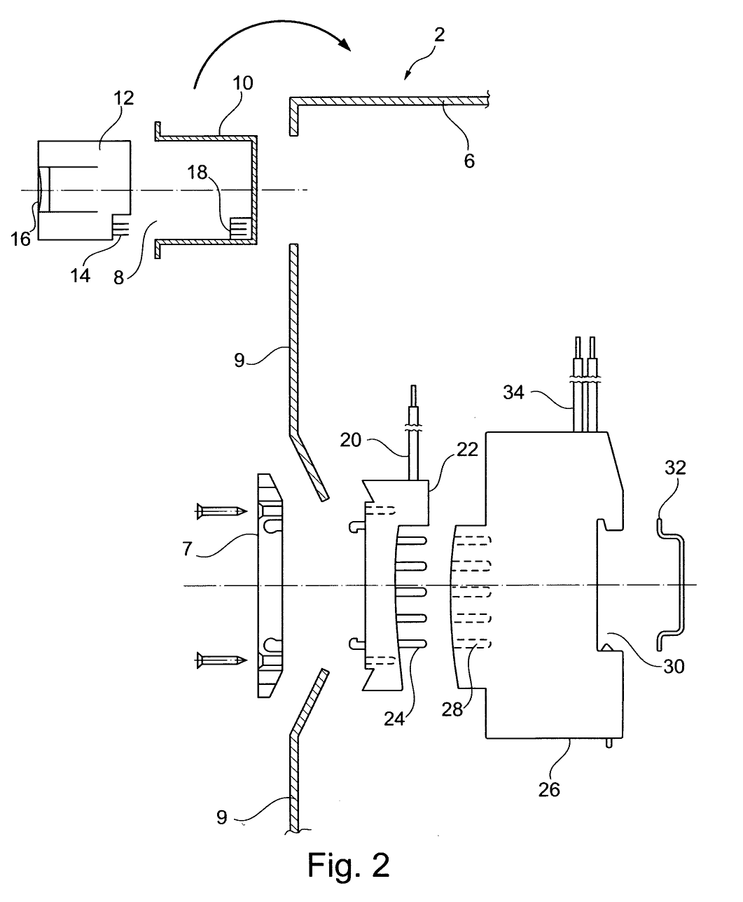

FIG. 2 shows a cross section through a switchboard 2 consisting of a back piece and a cover 6, 9. In the cover there is a recess 8 in which a module 10 can be accommodated. The module 10 contains a permanent power supply and fire alarm 12, which via connector 14 can receive an electric power supply while performing communication simultaneously. Also shown is a front plate 16 which provides access for e.g. replacement of batteries in the fire alarm 12. The connector 14 interacts with the operating socket 18 which via a cable 20 is connected to a coupling module 22 fixed by holder 7, where the coupling module 22 is also equipped with a connector 24, which interacts with a click-on module 26 equipped with a socket 28 corresponding to plug the 24. The module 26 can be clicked on through recess 30 on the rail 32 which is attached to the back wall. Fastening module 26 has connecting wires 34 to connect a power supply.

If the cover 6, 9 is mounted on the back wall the connector 22 will form connection in connector half part 26, and the two components will automatically lock into each other. The module 22 may for example include a voltage supply unit so that the electrical connection through cable 20 up to 18 is a low voltage connection. In an alternative embodiment, module 22 may provide electrical connection through cable 20 and 18 and then to a power supply 40. If the module 10 is positioned so as to make contact between the connector 14 to connector 18, electrical connection to the fire alarm 12 may be established. Connector 14 to socket 18 may also contain communications connection so that the fire alarm 12 can communicate through the device 22 and down through the connector 28 to the power system.

In an embodiment of the invention which is not illustrated in any figure, the connector/operating plug 18 may be arranged in the ceiling or wall of a room of the building, and is connected to the electric (supply) system of the building. Thereby, the fire detection unit 12 may by means of the connector/plug-connector 14 be easily installed to various locations of a building and at the same time be supplied with power from the connector/operating plug 18. The connection between the connector/plug-connector 14 and the connector/operating plug 18 preferably facilitates a holding/fixating function so that the fire detection unit 12 is automatically kept into position when connected to the connector/operating plug 18. Also or alternatively, the connector/operating plug 18 and/or the fire detection unit 12 may comprise other or further holding/fixating means to keep the fire detection unit 12 connected to the connector/operating plug 18. Such holding/fixating means may for example comprise latch and notch, a screw connection or the like.

In an embodiment of the invention, the above mentioned click module 26 may instead of being adapted to be connected to the mentioned power rail 32, be a module which is an integrated part of a back part (not shown in any figures) of the switchboard 2. The integration of the module may be achieved during the moulding process of the back part, it may comprise a screw connection, a latch/notch connection and/or the like.

Furthermore, the above mentioned coupling module 22 may in an embodiment of the invention be an integrated part of the cover 6, 9, e.g. achieved during the moulding process of the cover 6, 9, by means of a screw connection, a latch/notch connection or the like.

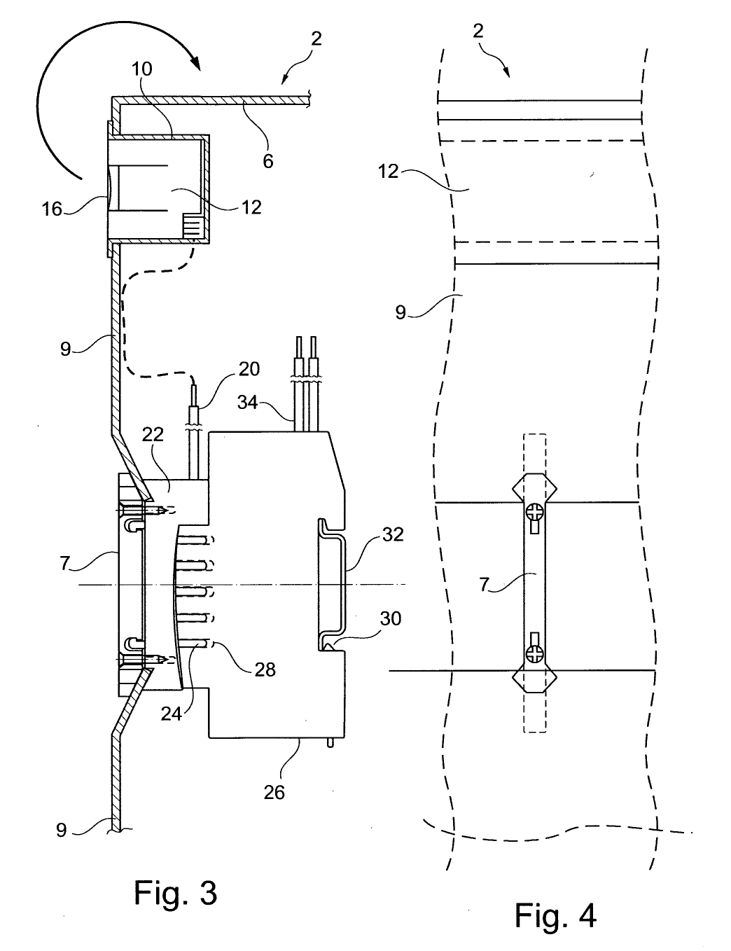

FIG. 3 shows the same section through a switchboard as in FIG. 2, but in FIG. 3 the fire alarm 12 is mounted and connectors 24, 28 are assembled. Other reference numbers are unchanged from FIG. 2.

FIG. 4 shows a detail of a switchboard 2, showing a front 9 and holder 7 for device 22. At the top of the switchboard 2 is shown a fire alarm 12.

FIGS. 2-4 shows that the fire alarm 12 is positioned relatively high in the switchboard, formed by the back wall and house 6, 9. By monitoring the temperature and any smoke development respectively in the fire alarm 12, both a temperature increase and/or with any smoke development establishes an air flow through the openings in the module 10 from inside the switchboard, starting from the switchboard bottom where heating of air may be caused by an electrical fault. This would mean that both smoke and temperature increase may rapidly be detected in fire alarm 12, which will be exposed to smoke and increasing temperature, respectively. By a detector located high in the switchboard, a very early warning of a developing electrical switchboard fire is provided before a fire may develop in any way. The fire alarm 12 can perform measurements in relation to predetermined levels so that a non-critical low warning level alarm communicated via a computer system signifying rising temperature in the switchboard, and an authorised electrical technician is to be called for making a service check as there is probably a bad connection. When temperature increase combined with smoke emission indicates that there is a substantial risk of fire, an audible alarm can be emitted directly from the fire alarm which may be provided with audible alarm means, or alarm can be transmitted via electronic communications to further alarm means in a building. If a further rise in temperature and smoke emission occurs, it will be possible for the fire alarm to make an earth connection forming a path between phase and earth, thus enabling the switchboard residual current circuit breaker to cut off the electrical connection to the switchboard automatically.

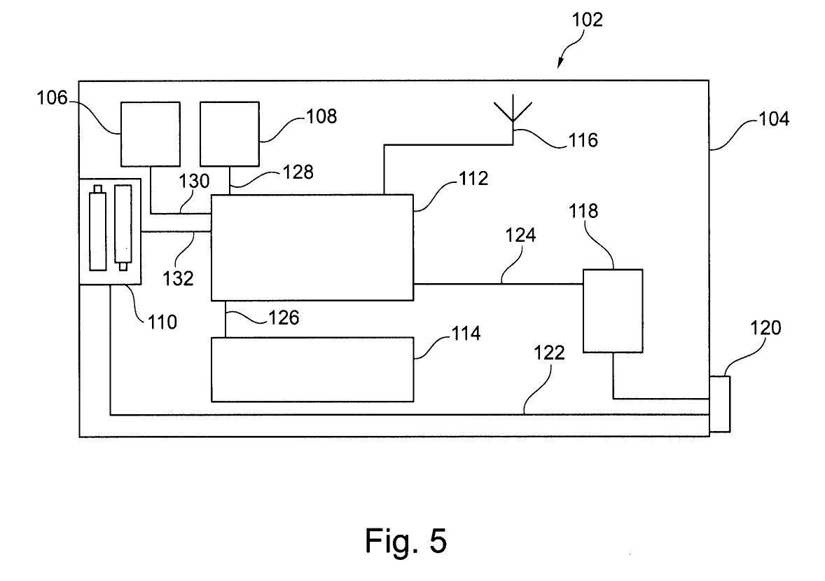

FIG. 5 shows a possible embodiment of a fire alarm 102 located in a casing 104. The fire alarm 102 contains, for example, a temperature sensor 106 and a smoke detector 108. Also shown is a power source here shown as a battery box 110. Fire alarm 102 also includes a processor or measuring computer 112 which is connected to a data storage device 114. Similarly, there is connection to an antenna 116 that may perform electronic communication, for example through a WiFi system to computer systems. Also shown is a module 118 which may perform power-line communication via connected units so that communication over the electrical network of the house is enabled. This is done by using the connection through the connector 120. The connector 120 is also connected to the battery module 110 via wire 122. Via wire 132, the battery module 110 is connected to the measuring- or processing unit 112. The smoke detector 108 is also connected to the measuring and processing unit 112 through wire 128. A communication path from the temperature sensor 106 to measuring and processing unit 112 is formed through the connection 130. The processing unit 112 communicates via connection 126 with, for example, a data storage device 114.

A fire alarm 102 arranged in casing 104 thus performs a number of different functions so that it is a very efficient fire alarm which in addition to a direct warning also may perform a continuous monitoring of both temperature and possible smoke development in many different types of switchboards. One possible use of the product is the traditional switchboard used in apartment or villa, but the fire alarm may equally well be applied to large industrial installations with far larger and far more complicated switchboards than those used in households. Similarly, a fire alarm of such type can be used in larger computer installations, since by incorporating the fire alarm directly in the electrical installations a much more rapid warning may be obtained if fire breaks out.

A fire alarm such as it is shown at 102 may include an audible alarm device, but an alarm signal may equally well be communicated either to a computer system via WiFi communication, or over the network power supply along with other electrical devices, including, for example, other fire alarms so that a critical alarm will immediately lead to a total alarm in a building. By incorporating a processor unit 112 and let it work with a data storage device 114, it will be possible to store various reference parameters in the system for the alarm levels to refer to. It is also possible to make a continuous, ongoing calibration of, for example, temperature data so that an alarm is not triggered because of the normal temperature development during the day, whereas sudden, unexpected temperature rises will immediately trigger an alarm. Likewise, it is not desirable that the smoke detector activates an alarm caused by e.g. cooking. It is thus advantageous to have the processor identify deviation from normal progress of the parameters detected or measured.

By using batteries in the battery compartment 110 and at the same time providing electrical power via the plug 120 it is achieved that the batteries have very long service life. By using rechargeable batteries a backup supply is ensured in case of power network failure so that the fire detection system can work even in situations where the 220 V supply is interrupted. Similarly, the batteries in the compartment 110 can be utilised, preventing the data from memory storage 114 from being deleted should the fire alarm be dismounted.

As the fire alarm is not directly supplied by the 220 V system and can be dismantled without opening the switchboard, anybody may dismantle or replace the unit.

1.-13. (canceled)

14. An apparatus for detecting a fire, the apparatus including at least one alarm signalling device and at least one detector, where the apparatus is supplied by at least one power source, wherein the detector may establish a detection level for at least one fire-dependent parameter, where the detector when surpassing a first threshold for at least one fire-dependent parameter activates at least one alarm signalling device, where the apparatus can interact with a switchboard, the switchboard comprising a mounting arrangement for mounting at least one electrical component, the switchboard being shielded by at least one cover, wherein the apparatus is placed in a recess in the cover, where the apparatus is connected to the switchboard by at least one connector, the connector providing at least power to the apparatus.

15. The apparatus according to claim 14, wherein the apparatus is located high in the switchboard cover.

16. The apparatus according to claim 14, wherein a first fire-dependent parameter detected by a first detector of the apparatus is the switchboard temperature.

17. The apparatus according to claim 14, wherein a second fire-dependent parameter detected by a second detector of the apparatus is smoke.

18. The apparatus according to claim 14, wherein the apparatus is adapted to compare the detected fire-dependent parameters with reference values, the reference values being stored in a memory storage device of apparatus, whereby the apparatus determines a standard condition and at least a first and a second alarm condition on the basis of the actual measurements/detections by the detectors.

19. The apparatus according to claim 14, wherein the apparatus by exceeding the second alarm condition activates an electrical connection through a switch and a resistance between a phase and an earth connection to activate a residual current circuit breaker in order to interrupt the power supply of the switchboard.

20. The apparatus according to claim 14, wherein the apparatus is adapted to communicate over a wireless network, the wireless network being connected with at least one computer.

21. The apparatus according to claim 20, wherein the wireless network is connected to additional fire alarms.

22. The apparatus according to claim 14, wherein the apparatus is adapted to communicate over an electrical network by transmitting/receiving signals over the electrical supply network, where computers or other fire alarms are also connected with the electricity network by means of communication means.

23. The apparatus according to claim 14, wherein said mounting arrangement comprises mounting rails.

24. A method for detecting a fire in electrical switchboards by means of an apparatus for detecting a fire, the apparatus including at least one alarm signaling device and at least one detector,
where the apparatus is supplied by at least one power source,
wherein the detector may establish a detection level for at least one fire-dependent parameter,
where the detector when surpassing a first threshold for at least one fire-dependent parameter activates at least one alarm signalling device,
where the apparatus interacts with a switchboard, the switchboard comprising a mounting arrangement, on which mounting arrangement is mounted at least one electrical component, the switchboard being shielded by at least one cover, and
where the apparatus is placed in a recess in the cover, where the apparatus is connected to the switchboard by at least one connector, the connector providing at least power to the apparatus.

25. A method where a fire alarm detects one or more fire-dependent parameters, where an alarm is triggered if at least one fire-dependent parameter exceeds a predetermined value, wherein the fire alarm is located in a recess in a cover of a switchboard, that power supply for the fire alarm is a low-voltage supply, and that assembly and disassembly of the fire alarm is effected without contact with the high voltage installation.

26. Method for registration of a fire, which apparatus contains at least one alarm signalling device and at least one detector, which apparatus is supplied by at least one power source, which detector is configured for establishing a measurable level of at least one fire-dependent parameter, which detector when surpassing a first threshold for at least one fire-dependent parameter activates the at least one alarm signalling device, wherein the apparatus comprises at least one plug-connector configured for connecting said apparatus to a connector for supplying said apparatus with electric power, where said connector is placed in a recess in a cover shielding a switchboard comprising at least one electrical component, and in that the connector connects the apparatus to the switchboard.
